(19) United States
(12) Patent Application Publication
(10) Pub. No.: US 2003/0099341 A1
(43) Pub. Date: May 29, 2003

(54) Method and system for providing access to a voice mail system

(75) Inventor: L. Lloyd Williams, Kanata (CA)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: BELL CANADA, Montreal (CA)

(21) Appl. No.: 09/995,971

(22) Filed: Nov. 28, 2001

(51) Int. Cl. H04M 3/42; H04M 11/00

(52) U.S. Cl. 379/211.02; 379/229; 379/88.18

(57) ABSTRACT

Direct access to a voice mail box hosted by a voice mail system (VMS) permits a requesting party to go directly to the voice mail box without first placing a call to the service subscriber who owns the voice mail box. Direct access can be enabled from call termination equipment, such as a dial-up directory service, or from a data network interface, such as a web page on a worldwide web server or a button embedded in an electronic mail message.

### CROSS-REFERENCE TO RELATED APPLICATIONS

This is the first application filed for the present invention.

### MICROFICHE APPENDIX

Not Applicable.

### TECHNICAL FIELD

The present invention relates to call processing in the Public Switched Telephone Network (PSTN), and, in particular, to a method of establishing a call connection directly to a voice mail system subscriber's voice mail box.

### BACKGROUND OF THE INVENTION

Automated Voice Mail Systems (VMSs) provide message management services that have become an increasingly popular means for receiving, storing, retrieving, and managing messages for telephone service subscribers. As is commonly practiced, telephone service providers leverage their position in the telephone network to provide these services because they can efficiently provide services that answering machines cannot. For example, VMSs are adapted to take messages for subscribers even when the subscribers' telephone line is being used for another call.

Methods for enabling voice mail services are well known in the art. Typically, when a calling party makes a telephone call to a telephone service subscriber, call set-up messages are generated and forwarded through the public switched telephone network (PSTN) to a service switching point (SSP) that serves the service subscriber's telephone. If the SSP is unable to complete the call connection (e.g. the call is not answered after a predefined number of rings, or the line is busy) and the telephone service subscriber also subscribes to a voice mail service, the SSP redirects the call to a VMS that hosts a voice mail box assigned to the service subscriber.

The redirection of the call is performed because of a line option set on the service subscriber's line in the SSP. The redirection involves formulating a redirect call setup message, generally an Integrated Services Digital Network-User Part (ISUP) Initial Address Message (IAM). A redirect IAM is differentiated from a call setup IAM in that it includes a redirecting number parameter, an original called number parameter, and a redirection information parameter. The telephone number of the VMS is inserted in the called party number field, which is a mandatory variable part of the IAM. The telephone number of the service subscriber is inserted in the redirecting number parameter.

Upon receipt of the redirect IAM information, the VMS inspects information extracted from an optional part of a signaling information field in the IAM to determine called party details, including presentation information located in the original called number parameter. The redirecting number and redirection information parameters are used to select a voice mail box for the call. In particular, the redirecting number is used to identify the service subscriber's voice mail box, and, in certain voice mail systems, a redirect reason code is used to select a particular message to be played to the caller. The last four bits in the redirection information parameter (the redirecting reason code) may be used to select one of a plurality of messages to prompt the calling party to leave the voice mail message.

Although service provider supported voice mail systems have become increasingly popular, they suffer from a disadvantage that restricts their utility. The disadvantage is that although a caller may wish to be routed directly to voice mail, that option is either generally not available, or is very akward to use. There are many circumstances that make direct access to voice mail desirable. For example, a caller may wish to leave a voice message at a time when the called party may not wish to be disturbed, such as late at night. Alternatively, the caller may simply wish to leave some information for the called party, and prefer to do so without disturbing the called party. However, the use of the redirecting number and redirection information parameters to identify a voice mail box makes direct access to a voice mail box difficult, because a direct call connection to the VMS does not contain either of the redirection information or redirecting number parameters. The VMS is programmed to treat calls that do not contain redirecting information as requests to access maintenance features, so the calling party is routed to a maintenance interface, which is reserved for the voice mail subscriber and functions in a manner well known in the art.

Direct access to voice mail is also desirable for Internet-based directory services and for entities that advertise using Internet web-pages who wish to offer a voice mail equivalent to a “click to talk” icon. As is known in the art, a telephone connection can be set up in response to a predetermined event (e.g. selecting an icon on a web page to initiate a request for a voice connection) initiated by a calling party. This functionality may be implemented using methods described in Applicant's co-pending U.S. Pat. No. 6,236,722 entitled METHOD AND APPARATUS FOR COMPLETING A VOICE CONNECTION BETWEEN FIRST AND SECOND VOICE TERMINALS IN A SWITCHED TELEPHONE NETWORK, which issued on Aug. 1, 2000, and is incorporated herein by reference. However, implementing “click to voice mail” functionality is not available and has not been described in the prior art.

There is also no facility to permit a dial-up directory service provider, or call assistant (whether automated or not) from providing a calling party with an option for direct access to a voice mail box. It would be advantageous for a directory service or other service provider to offer callers the option of direct access to a selected service subscriber's voice mail box.

Accordingly, there exists a need for a method and system for providing access to a voice mail box that enables a party to record a message in a service subscriber's voice mail box without first attempting to complete a call to the service subscriber.

### SUMMARY OF THE INVENTION

It is therefore an object of the invention to provide a method for enabling direct access to a voice mail box associated with a service subscriber to a voice mail system (VMS).

It is another object of the invention to provide a method and system for enabling a ‘click to voice mail’ option from a web page or an electronic mail message to enable a user browsing the Internet to request a call connection to an associated voice mail box without first attempting a call to the subscriber.

A further object of the invention is to provide a method and system for enabling directory service providers to provide direct access to the voice mail boxes of VMS subscribers.

The invention therefore provides a method that comprises formulating and issuing a call set-up message for initiating the establishment of a call connection to a VMS. The call set-up message has a format reserved for a redirected call set-up message issued by a service switching point (SSP) in response to an uncompleted call to the service subscriber. For example, if the call is issued into a signaling system 7 (SS7) CCS network, the call set-up message is an integrated users digital network-user part (ISUP) initial address message (IAM) containing (in an optional part of a signaling information portion of a signaling information field) a redirecting number parameter, an original called number parameter, and a redirection information parameter, in conformance with a SS7 standard. The IAM contains all of the information required by the VMS to select a voice mail box, and a greeting message associated therewith. In particular, the IAM contains a directory number (DN) of the service subscriber in the redirecting number parameter, and a redirecting reason code in the redirection information parameter. Preferably the redirecting reason code is a reason code used to indicate that the IAM is for a direct access call.

The invention also provides a call control node that receives a message in response to a request for direct access to the voice mail box by a requesting party. The call control mode formulates the IAM that is used to initiate establishment of a call connection to the VMS when sent into the CCS network.

Preferably the call control node comprises a call control application (CCA) adapted to control the call control node (CCN). The CCN is a physical node in the CCS network and a virtual switching point in the switched telephone network. The CCA is adapted to receive the message, and to extract an identifier of the requesting party, an identifier of the service subscriber, and an identifier of the VMS.

The connection request message may be issued by an Internet Protocol (IP) server, such as, for instance a worldwide web (WWW) server. The WWW server is adapted to receive click-to-voice mail notifications from a web page or an electronic mail message. The connection request message sent to the CCA preferably specifies the three identifiers. Preferably the CCA also receives from the connection request message a redirecting reason code that is inserted in the redirected IAM. The CCA is adapted to control the CCN to initiate the establishment of a call connection between the requesting party's DN and the CCN, and to initiate the establishment of a call connection to the VMS with the IAM.

Alternatively the connection request message may be issued by call termination equipment, such as a dial-up directory service, in response to a request to access a voice mail box by the requesting party. Calls to the call termination equipment are routed through a virtual instance of the call control node to permit the call control node to control the call. This enables the call control node to release the requesting party from the call termination equipment and reconnect the requesting party to the selected mail box in a single uninterrupted operation.

### BRIEF DESCRIPTION OF THE DRAWINGS

Further features and advantages of the present invention will become apparent from the following detailed description, taken in combination with the appended drawings, in which:

FIG. 1 is a schematic diagram illustrating principal elements of a system in accordance with the present invention for enabling a calling party to request a direct connection to a voice mail box of a VMS;

FIGS. 2a and 2b are message flow diagrams schematically illustrating principle steps involved in establishing a connection to a VMS using the system illustrated in FIG. 1;

FIG. 3 is a schematic diagram illustrating principal elements of a system in accordance with the invention for enabling an Internet user to request a direct connection to a voice mail box of a VMS from a web page or an electronic mail message;

FIG. 4 is a message flow diagram schematically illustrating principle steps involved in establishing a connection to a voice mail box of the VMS using the system illustrated in FIG. 3;

FIG. 5a is a schematic diagram of a web browser application enabled interface for offering a “click to voice mail” request;

FIG. 5b is a schematic diagram of an electronic mail message for enabling a recipient of the electronic mail message to establish a direct access to a voice mail box of a sender of the message; and

FIG. 6 is a schematic block diagram of principal fields in a SS7 ISUP IAM, used in the present invention to initiate a call connection to the VMS.

It will be noted that throughout the appended drawings, like features are identified by like reference numerals.

### DETAILED DESCRIPTION OF THE PREFERRED EMBODIMENTS

The present invention enables a user to establish a call connection directly to a voice mail server (VMS) of a service subscriber, without first attempting to establish a call connection to the service subscriber. The call connection is established in response to a predetermined event triggered by a requesting party. The requesting party may trigger the event by clicking an icon on an Internet web page, or an electronic mail message, or by selecting a voice mail box option from a directory service. The directory service may be accessed through a switched telephone network, the Internet, PCD, or any other automated system for exchanging information.

In a first embodiment, a voice mail system (VMS) 10 is accessed by a requesting party using a telephone 12 connected by a subscriber line 14 to a public switched telephone network (PSTN) 16 at a service switching point (SSP) 20a. As is known in the art, the PSTN 16 comprises a plurality of SSPs only four of which, 20a-20d, are shown. The SSPs are respectively connected to the PSTN 16 and its associated common channel signaling (CCS) network, only a portion of which is shown. Many of the SSPs serve a plurality of subscriber lines (such as subscriber line 14), and also serve one or more integrated services digital network (ISDN) trunks that are connected to peripheral devices such as voice mail system 10. The SSPs 20d and 20c serve the VMS 10 and a directory service (DS) 22, respectively, with ISDN (Integrated Services Digital Network) or SMDI (Simplified Message Desk Interface) trunks. The trunks convey call control messages as well as bearer traffic (i.e. the voice/data content carried over an established call connection). The DS 22 is adapted to receive calls, provide a service of locating a directory number for a called party, and optionally requesting a re-connection of the call to the located directory number.

The CCS includes a plurality of signal transfer points 28 (STPs) used to route call control messages between SSPs and other signaling points, such as signal control points (SCPs), not shown. A relatively recent addition to the CCS network is a call control node (CCN) 26, also referred to as a virtual switching point (VSP), described in Applicant's U.S. Pat. No. 6,226,289 which issued on May 1, 2001, the specification of which is incorporated herein by reference. The CCN 26 interfaces with an STP 28, and a virtual instance 30 of the CCN 26 functions as a virtual switching point located between terminating ends of an enhanced ISDN-user part (E-ISUP) 31 trunk that connects the SSP 20b and the SSP 20c. The CCN 26 is controlled by a call control application (CCA) 32. The CCA 32 provides control functions to the CCN 26 to direct call processing and generates redirected call setup messages used for direct access to voice mail boxes, as will be explained below in detail. The CCN 26 and CCA 32 are interconnected by a local area network (LAN) 34, that may also interface with an intranet 36. The intranet 36 interfaces with an Internet protocol (IP) network 38. The IP network 38, intranet 36, and LAN 34 serve to convey IP messages from the DS 22 to the CCA 32. This connection may be used to request a call disconnection and redirection.

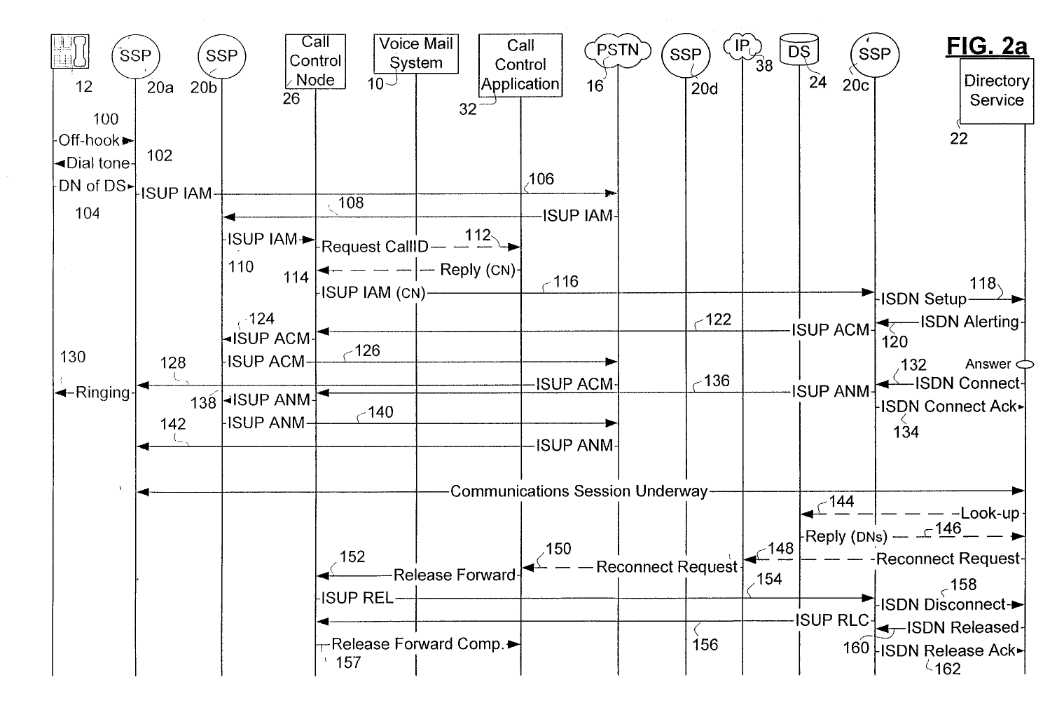

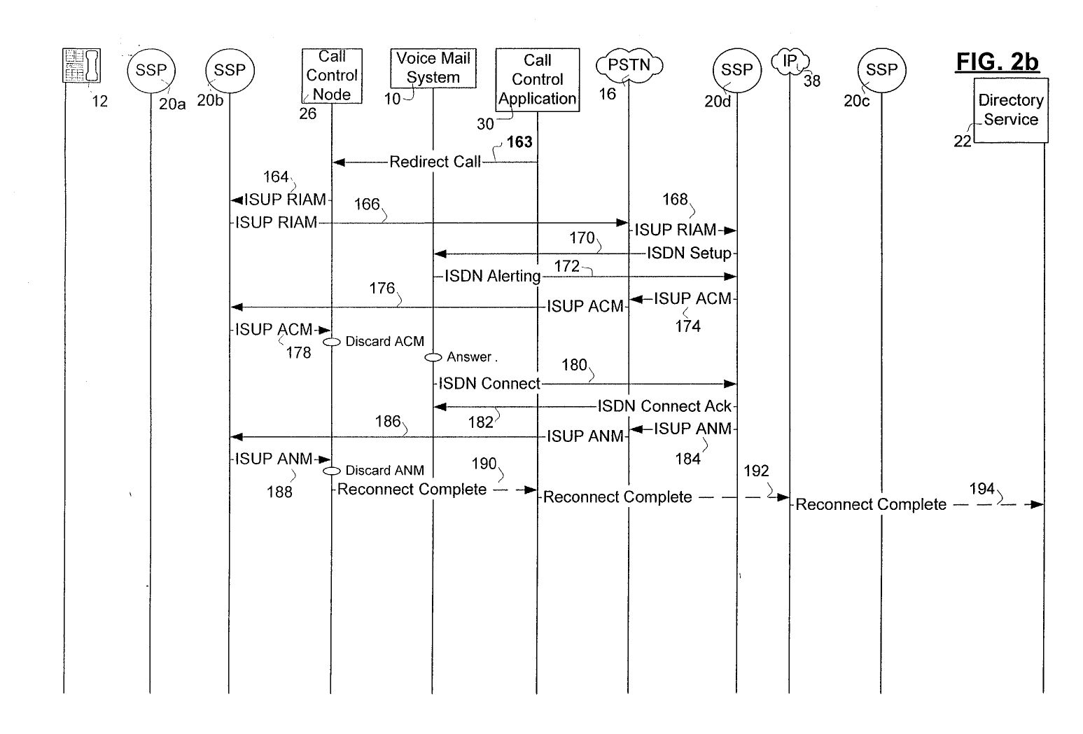

FIG. 2a is a call flow diagram schematically illustrating principal messages exchanged in order to provide a directory service enhanced by the capacity to reconnect calls directly to a voice mail box, in accordance with the invention. A requesting party accesses the service using the telephone 12 by dialing a predetermined number, “411”, for example. The SSP 20a detects the off-hook condition, in step 100, and applies dial tone to the line (step 102). The requesting party dials the number (DN) associated with the directory service (step 104). The SSP 20a translates the dialed digits to determine a trunk to reserve for the call, and forwards an initial address message (IAM) over the CCS network to a switch (not shown) in the PSTN 16 to which the reserved trunk is terminated (step 106). The switch translates the dialed DN contained in a called party number parameter in a mandatory variable part of a signaling information part of a signaling information field of the IAM, reserves a determined trunk, and forwards the IAM to a next switch in the PSTN 16. In this manner a bearer path is reserved, hop-by-hop through the PSTN, until, in step 108, the IAM is forwarded to the SSP 20b. The SSP 20b translates the DN. Translation tables in the SSP 20b direct the SSP 20b to reserve the E-ISUP trunk 31 for the call, and to forward the IAM to the CCN 26 (step 110), which is a virtual services switching point (CCN 30) in the E-ISUP trunk 31, as explained above.

As will be understood by those skilled in the art, call connections are not necessarily routed over E-ISUP trunks. Calls to the directory service's DN are routed through an E-ISUP trunk somewhere in the network so that the services of the CCN 26 can be utilized, but the way in which this is accomplished is a matter of design choice and may vary with implementation. One other way of so doing involves using an inter-exchange carrier code, as described in Applicant's co-pending U.S. patent application Ser. No. 09/798,085, filed on Mar. 2, 2001 and entitled METHOD AND APPARATUS FOR EFFECTING TELECOMMUNICATIONS SERVICE FEATURES USING CALL CONTROL INFORMATION EXTRACTED FROM A BEARER CHANNEL IN A TELECOMMUNICATIONS NETWORK, which is incorporated herein by reference.

The CCN 26 receives the IAM, and passes at least a part of the content of the IAM to the CCA 32 (step 112), including the called and calling party number parameters and other information required to determine a purpose of the call and log the call connection. The CCA 32 has no service features to invoke at this point in the call connection reserved, and so directs the CCN 26 to advance the IAM to the SSP 20c (step 114). The CCN 26 forwards the IAM to the SSP 20c (step 116), which serves the directory service (DS) 22. The SSP 20c therefore issues an ISDN set-up message to the DS 22 (step 118), and receives an acknowledgement of the set-up message in the form of an ISDN alerting message (step 120). Once the alerting message is received, the SSP 20c returns an ISUP address complete message (ACM) that is relayed back through successive switches in the reserved call connection. The ACM is sent to the CCN 26 (step 122), relayed to the SSP 20b (step 124), relayed through the switches in the bearer path in the PSTN 16 (step 126), and finally relayed to the SSP 20a (step 128), which completes a connection between the subscriber line 14 of the calling party and permits the calling party to hear ringing applied to signal an attempt to connect to the DS 22.

When the DS 22 allocates resources for the call and is ready to connect to the requesting party, it sends an ISDN connect message to the SSP 20c (step 132). The connect message is acknowledged (step 134), and an ISUP answer message (ANMs) is sent back to the CCN 26 (step 136), and then relayed to the SSP 20b (step 138), and through the PSTN 16 (step 140) to the SSP 20a (step 142). The call connection is now in service and the communications session begins. Interaction between the calling party and the DS 22 is not illustrated, but as will be understood by those skilled in the art, the calling party interacts with the DS 22 in one of a number of known ways, a live operator or voice recognition engine, for example, to identify a party for which a directory number is required. During this interaction, the DS 22 may make one or more queries to the directory service database 24, in a manner well known in the art, to locate a directory record associated with the party for which the directory number is required. It is assumed that in the course of the communications session the requesting party is presented with, and selects an option to direct the call directly to the voice mail box of the identified party.

In step 144, the DS 22 responds to the selection by the requesting party, and queries the directory service database 24 to retrieve the identified party's DN, and the DN of the identified party's VMS. The reply to the query contains both DNs (step 146), which the DS 22 includes in a reconnect request message that is sent through the IP network 38 (step 148) to the CCA 32 (step 150). The reconnect request message (step 150) also contains information required to identify the call connection setup through the CCN 26 (dialed number and calling line identification, for example, or any one of the other mechanisms described in Applicant's U.S. Pat. No. 6,226,289), and may also contain an indicator of a redirecting reason code. The CCA 32 commands the CCN 26 to release the part of the call connection between the CCN 26 and the DS 22, by issuing an ISUP release (REL) message (step 152). In step 154, the REL message is sent to the SSP 20c. The ISUP REL message is acknowledged with an ISUP release complete (RLC) message, in step 156. On receipt of the RLC message, the CCN 26 returns a message (step 157) to the CCA 32 to inform the CCA 32 that the release forward is complete. Meanwhile, the SSP 20c forwards an ISDN disconnect message to the DS 22, in step 158, which is acknowledged with an ISDN released message, in step 160, and in step 162, the ISDN release is acknowledged.

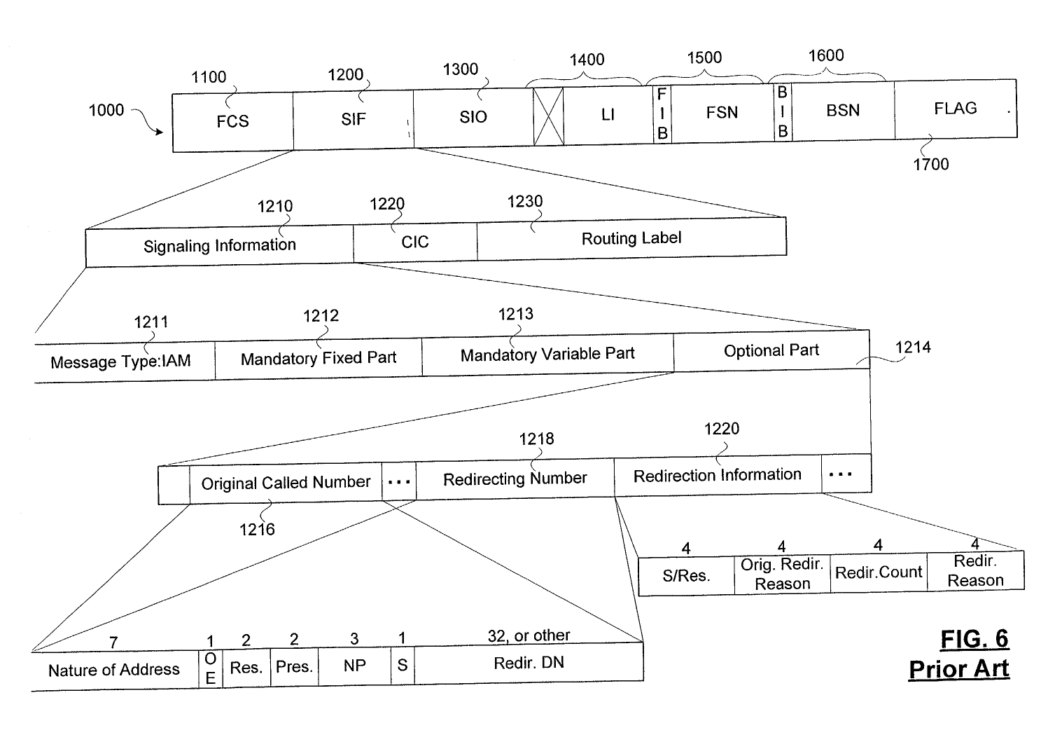

FIG. 2b continues the call flow where CCA 32 then prompts the CCN 26 to initiate an extension of the remaining call connection to the VMS 10 using a redirected IAM (RIAM) (step 163). The RIAM is identical to any other IAM and is formulated according to the SS7 standard. The RAIM includes original called number, redirecting number, and redirection information parameters in a optional part of the signaling information part of the signaling information field of the RIAM. The format and content of the RIAM are discussed below in detail with reference to FIG. 6.

The RIAM is issued to the SSP 20b (step 164), and forwarded from there, hop-by-hop through the PSTN 16 (step 166), to the SSP 20d (step 168), which serves the VMS 10. The SSP 20d forwards an ISDN set-up message to the VMS 10 (step 170), and, upon receipt of the alerting message in reply (step 172), issues an ACM that is relayed back through the reserved extension of the call connection. The ACM is passed through the PSTN 16 (step 174) to the SSP 20b (step 176), and from there to the CCN 26 (step 178), which logs and discards the ACM. The VMS 10 answers the call, and sends a connect message to the SSP 20d (step 180), which is acknowledged in step 182. In step 184, the SSP 20d issues an ANM through the PSTN 16 that is relayed to the SSP 20b and the CCN 26 in steps 186 and 188, respectively. The CCN 26 logs and discards the ANM, and the call connection extension is established between the CCN 26 and the VMS 10.

The VMS 10 answers the call and determines the voice mail box of the service subscriber to whom the call is directed using the information contained in the redirecting number parameter of the IAM. The service subscriber may have recorded two or more greetings that are respectively associated with calls that are forwarded to the VMS for different redirecting reasons, as is known in the art. A redirecting reason code may be included in the redirection information parameter, and preferably, a new code for a direct call is used to signify the redirecting reason in this case, to permit the service subscriber to tailor a greeting message appropriate to this type of call.

Once the call connection extension is established, the CCN 26 notifies the CCA 32 (step 190). In response, the CCA 32 may optionally inform the DS 22 that the request has been successfully completed. The message sent to the DS 22 may be a reconnect complete message, for example, that is relayed through the IP network (step 192) to the DS 22.

It should be noted that this example has been described with reference to a directory service accessed through a dial-up connection. However, as will be understood by those skilled in the art, the directory service could also be an online service accessed through the Internet, in which case access is through an interactive directory service application, well known in the art. It should be further understood that the directory service is only one example of a service that can be adapted to offer the direct to voice mail option. Practically any telephone termination, or Internet interface can be equipped with an interface to enable the direct to voice mail option using the invention. This could include any wireless control mechanism as well. Directory access using a personal communications device (PCD) provides another example of a control mechanism that parallels the Internet example.

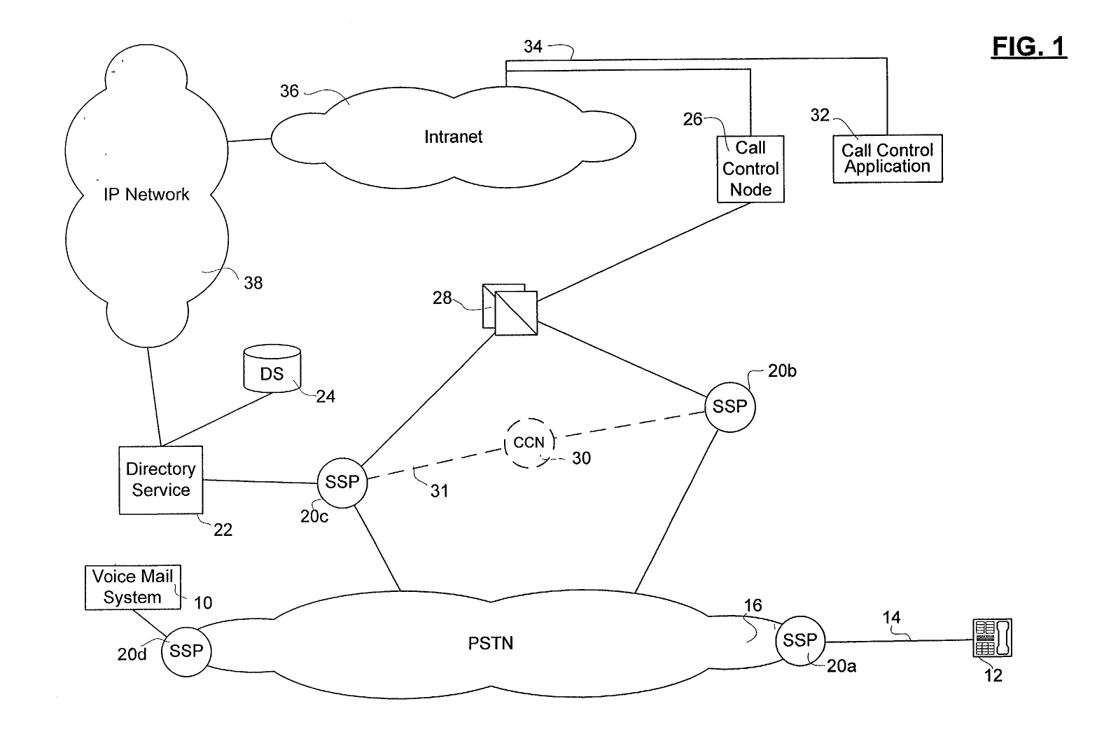

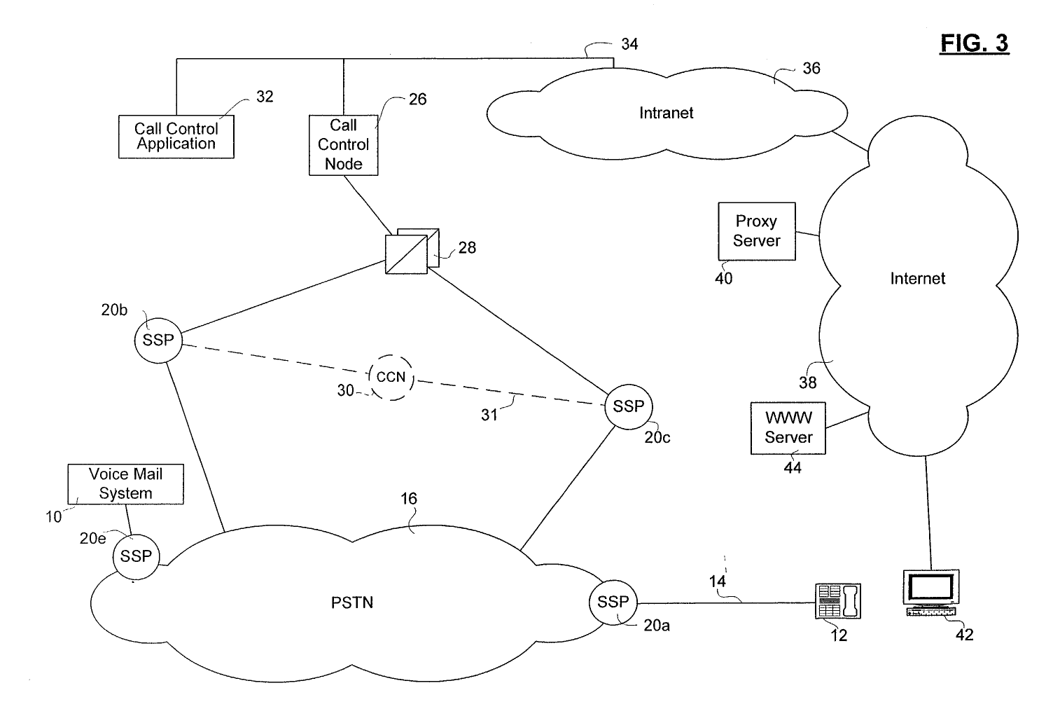

FIG. 3 shows a network configuration for implementing a second embodiment of the invention, which permits a requesting party to establish a call directly to a voice mail box hosted by VMS 10 from a worldwide web page available, for example, on the Internet 38 or from an electronic mail message. The requesting party uses a web browser application that runs on a computer 42, or an applet embedded in the electronic mail message to access a worldwide web (WWW) public server on the Internet 38. The WWW server 44 may be adapted to process and exchange call request messages with the CCA 32 either directly, or as will be described in the following example, indirectly through a proxy server 40, in order to request call connections in accordance with the invention. Apart from the signaling path for accessing the CCA 32, the remainder of the system illustrated in FIG. 3 remains identical to that described above with reference to FIG. 1. The PSTN 16 is used to complete the call, and the CCN 26-CCA 32 pair serves a point of origin for call control signaling used to establish the call to the VMS 10 via the STP 28. As explained above, the CCN 26 serves as a virtual switching point 30 in the E-ISUP trunk 31. As is known in the art, the Internet 38 comprises a plurality of Internet protocol (IP) routers (not illustrated) and both public and private servers. The WWW server 44 generally stores a plurality of worldwide web pages used to present information to Internet users.

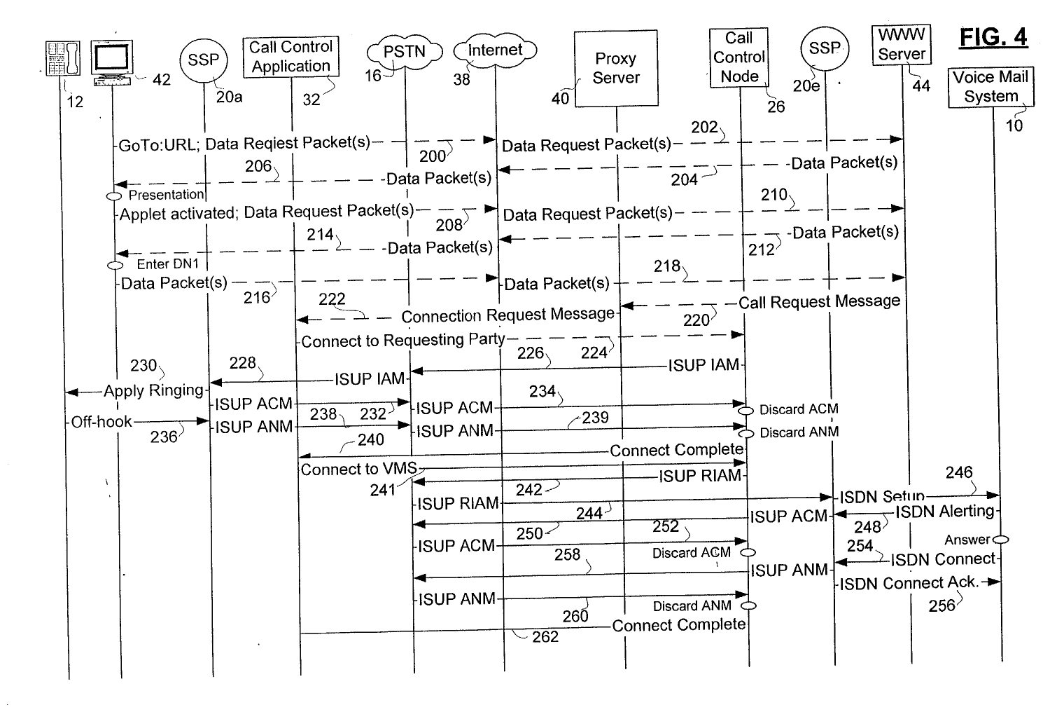

FIG. 4 illustrates principal steps involved in establishing a call directly to the VMS 10 using the network configuration illustrated in FIG. 3. In step 200, the requesting party, using the web browser application or an applet embedded in an electronic mail message, accesses the WWW server 44 by clicking on a hotlink, or otherwise selecting a universal resource locator (URL) identifying a web page stored on the WWW server 44. The data request is routed through the Internet 38 to the WWW server 44 (step 202), which returns IP data packets through the Internet 38 (step 204) to an access server (not shown) used by the requesting party, which duly relays the packets to the web browser application (step 206). The requesting party is thus presented with information associated with the web page. The requesting party selects a ‘click to voice mail’ button, which prompts the web browser to generate and send a data request for an applet associated with the selected button (step 208). The data request for the applet is forwarded through the Internet 38 to the WWW server 44 (step 210), and the response provides presentation information associated with a graphical user interface (GUI) applet that is returned through the Internet 38 (step 212) to the web browser (step 214). The applet is executed yielding a GUI that is displayed to the requesting party, inviting the requesting party to enter a directory number (DN) of a subscriber line that will be used by the requesting party to receive a call to be set up to the selected voice mail box. The requesting party supplies the DN of telephone 12, and the data is sent in a packet(s) through the Internet 38 (step 216) to the WWW server 44 (step 218). The WWW server 44, then formulates a message to the CCA 32, or a proxy server 40 requesting that a call be set up between the DN entered by the requesting party and the VMS of the selected party (step 220) using a call request message that includes a service user's DN. The proxy server 40 issues a connection request message to the CCA 32 (step 222) containing the DN supplied by the requesting party, the DN of the service subscriber, and the DN of the VMS 10. The connection request message may contain an indicator that the IAM used to initiate the establishment of a call connection to the DN of the VMS 10 is a direct call to the mail box.

On receipt of the connection request message, the CCA 32 commands the CCN 26 to initiate a call connection to the DN that the requesting party input (step 224). The CCN 26 subsequently formulates an IAM and forwards the IAM through the PSTN 16 (via the SSP 20b not illustrated) (step 226). The IAM is forwarded hop-by-hop to the SSP 20a (step 228). The SSP 20a applies ringing to the subscriber line 12 (step 230), and returns an ACM through the PSTN 16 (step 232) that retraces the bearer connection to the CCN 26 (step 234). The CCN 26 discards the received ACM. When the requesting party answers the ringing telephone 12 (step 236), the SSP 20a detects an off-hook condition of the telephone 12, and issues an ANM that is forwarded hop-by-hop through the PSTN 16 (step 238) to the CCN 26 (step 239). The CCN 26 discards the ANM and the call connection to the requesting party is complete. Consequently, the CCN 26 returns a connect complete to the CCA 32 (step 240), which responds by commanding the CCA 32 to connect to the VMS 10 using a redirect message.

The CCN 26 responds by initiating the establishment of a second part of the call connection by issuing a subsequent IAM through the PSTN 16 (via the SSP 20c; not illustrated) (step 242) to the SSP 20e (step 244). The SSP 20e, upon receipt of the IAM, issues a setup message over an ISDN trunk to the VMS 10 (step 246) The VMS 10 returns an alerting message (step 248), which triggers the SSP 20e to issue an ACM that is relayed back along the reserved bearer connection in the PSTN 16 (step 250) to the CCN 26 (step 252), where the ACM is logged and discarded.

Once the VMS 10 has allocated resources to the call, it issues a connect message to the SSP 20e (step 254). The connect message is acknowledged (step 256), and the SSP 20e issues an ANM back through the switches in the PSTN 16 that are part of the call connection to the VMS 10 (step 258). The ANM is relayed to the CCN 26, in step 260, where the ANM is logged and discarded. The call connection between the requesting party and the VMS 10 is thus completed, and the CCN 26 returns a connect complete message to the CCA 32 (step 262).

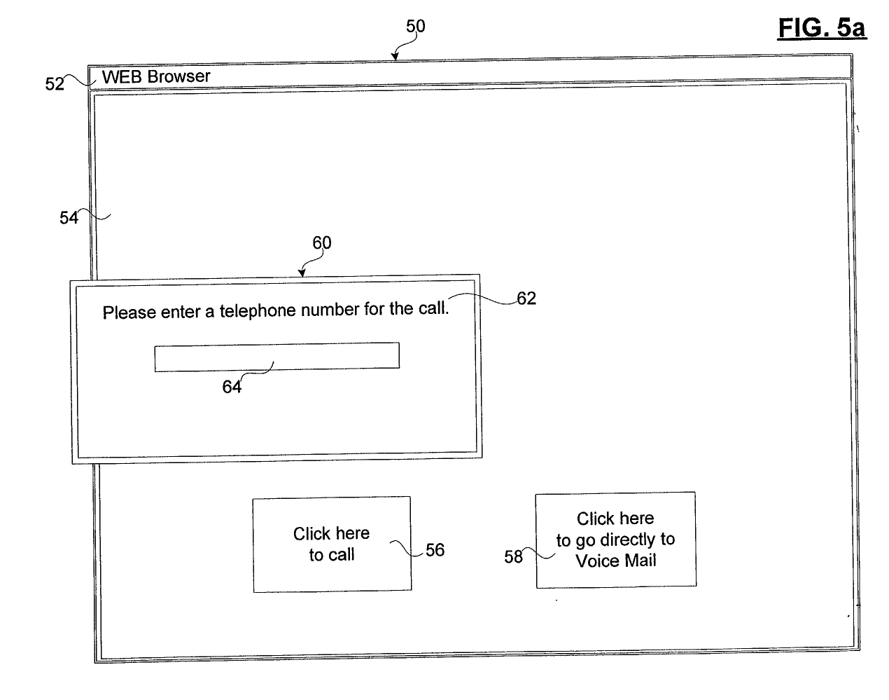

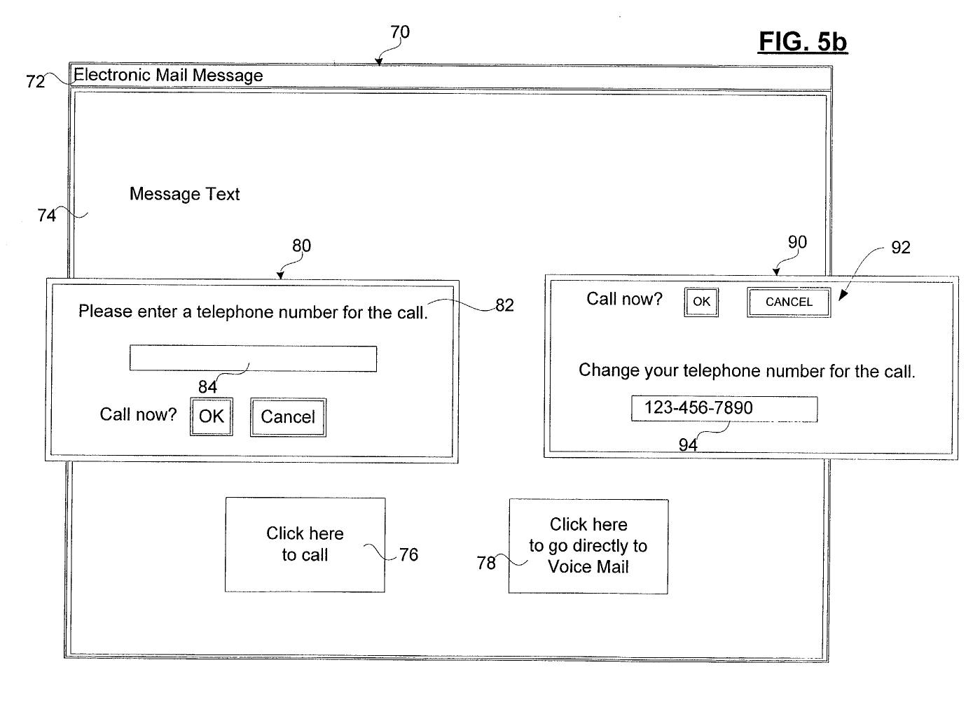

An exemplary embodiment of an interface for requesting a direct call to a voice mail box is schematically illustrated in FIG. 5a. The web browser application 52 provides a graphical user interface (GUI) through which information is presented to the user, and the user can issue commands, which include navigation commands for browsing or “surfing” the Internet. Most web browser applications permit users to specify a URL in more than one manner. The web browser 50 has a header section 52, and a content section 54. The content section 54 displays a web page that contains, among other information, two buttons, a “click to talk” button 56 that is used to initiate calls to a telephone service subscriber associated with the web page, and a “click to voice mail” button 58 enabled by the present invention to initiate direct call connections to a voice mail box.

When a user of the web browser application selects the “click to voice mail” button 58, the WWW server 44 that displays the web page may require the input of a DN in order to complete the click to voice mail operation, as described above with reference to FIG. 4. If a “cookie” is retrieved from the requesting party's computer 42 (FIG. 3) that contains a telephone number, that number is displayed in the telephone number field.

As is common knowledge, the selection of the “click to voice mail” button 58 generally involves highlighting the button and pressing return, or left-clicking on the button using a pointing device, such as a mouse. This prompts the web browser application to request presentation information for a button's hyperlink. In this case the button's hyperlink activates an applet, which generates an applet GUI 60. The applet GUI 60 presents text 62 and a field for inputting text 64. The text 62 elicits input from the user of a directory number to be used to set up the call. This is only one example of an interface for requesting a call to a voice mail server that can be offered over the Internet 36. After the GUI 60 is displayed, the user may initiate the call by selecting the “OK” button, or cancel the call by selecting the “cancel” button. The telephone number, if provided, may also be changed.

Another exemplary embodiment of an interface for requesting a direct call to a voice mail box is schematically illustrated in FIG. 5b. The electronic mail message 70 provides a well known messaging vehicle that permits users to exchange text and graphic information in a manner well known in the art. The electronic mail message 70 has a header section 72 and a message text section 74. The message text section 74 permits the insertion of text and other objects that are incorporated into the message. In the example shown, the text message includes a “click to talk” button 76 that is used to initiate calls to a telephone service subscriber who sent the electronic mail message, and a “click to voice mail” button 78 enabled by the present invention to initiate direct call connections to the telephone subscriber's VMS mail box.

When a recipient of the electronic mail message selects the “click to voice mail” button 78, an applet launches a message to, for example, the WWW server 44, and the WWW server responds to the message, for example, by inspecting a “cookie” sent from the requesting party's computer 42 (FIG. 3) to determine if it contains a telephone number. If so, that number is displayed in a telephone number field 94 of a GUI 90 returned to and displayed on the computer display screen. Otherwise, a GUI 80 requests the input of a telephone number in number field 84.

As described above, the selection of the “click to voice mail” button 78 generally involves highlighting the button and pressing return, or left-clicking on the button using a pointing device, such as a mouse. This activates the applet, which generates the message to the WWW server 44. After the appropriate GUI 80,90 is displayed, the electronic mail recipient may initiate the call by selecting the “OK” button, or cancel the call by selecting the “Cancel” button.

FIG. 6 illustrates components particular to a redirected IAM, in conformance with a signaling system 7 (SS7) standard. A standard ISDN message signaling unit (MSU) 1000 contains a plurality of fields, including a frame check sequence (FCS) byte 1100, a signaling information field (SIF) 1200, a service indicator octet (SIO) 1300, two spare bits and a six bit length indicator (LI) 1400, a forward indicator bit and forward sequence number 1500, a backward indicator bit and backward sequence number 1600, and a flag 1700 used to identify the beginnings and ends of MSUs 1000.

The SIF 1200 contains three parts; a signaling information part 1210, a circuit identification code (CIC) 1220, and a routing label 1230. The CIC 1220 identifies a circuit (e.g. a timeslot on a TI trunk) between switches in the PSTN 16 identified by an originating point code (OPC) and a destination point code (DPC) contained in the routing label 1230. The CIC 1220 and routing label 1230 are used for routing the MSU one hop in the PSTN 16. The signaling information part 1210 stores service information for the call connection to be established.

The signaling information part 1210 has a message type indicator 1211, which is an IAM in this case, and a mandatory fixed part 1212, a mandatory variable part 1213, and an optional part 1214. The mandatory fixed part 1212 and mandatory variable part 1213 of IAMs contain information used to establish the call connection, and the a called party number that is used at every hop to determine a CIC 1220 and routing label 1230 for the next hop.

The optional part 1214 of a redirected IAM contains an original called number parameter 1216, a redirecting number parameter 1218, and a redirection information parameter 1220.

The original called number parameter 1216 is used to indicate the address of the party that initiated the call redirection. In accordance with the invention, the original called number parameter 1216 is preferably filed with the directory number of the voice mail subscriber who owns the voice mail box to which the call is directed. The redirecting number parameter 1218 is used to indicate the telephone number from which the called number was last forwarded. In accordance with the invention, the redirecting number parameter 1218 is also filed with the directory number of the voice mail service subscriber, so that the VMS 10 can correctly identify the voice mail box to which the requesting party is to be connected.

The values of the redirection information parameter 1220 include a four-bit redirection reason. The redirecting reason value is a code that can be used by a VMS to select a greeting message, in order to provide the calling party with an appropriate message (e.g. “Thank you for leaving a message.” as opposed to “I'm sorry I cannot take your call right now.”). The default redirecting reason code (0000) indicates that the reason is unavailable/not known. The redirecting reason code 0011 indicates that the redirection was unconditional, which may be used for calls that are redirected for any reason other than unsuccessful call completion. A new redirecting reason code may be used to indicate a call routed directly to voice mail, to ensure that an appropriate message is played to the calling party. If so, one of the unassigned redirecting reason codes can be used for this purpose.

Although the invention has been explained with reference to calls completed exclusively through the PSTN, it will be understood by those skilled in the art that such calls can be set up in other ways. For example, the direct to voice mail option may be selected from a web page, electronic mail message or a directory server by a user of a wireless application protocol (WAP) enabled telephone or a personal communications service (PCS) device. The requesting party may also be enabled to request a voice-over-IP (VOIP) connection, in which case the CCN 26 sets up the call to the requesting party through a VOIP gateway, in a manner well known in the art. These and other alternatives have been contemplated and are within the scope of the invention.

Consequently, the embodiments of the invention described above are intended to be exemplary only. The scope of the invention is therefore intended to be limited solely by the scope of the appended claims.

We claim:

1. A method of providing direct access to a voice mail system (VMS) hosting a voice mail box associated with a service subscriber, the method comprising steps of:
formulating a call set-up message for initiating the establishment of a call connection to the VMS, the call set-up message having a format reserved for a redirected call set-up message issued by a service switching point (SSP) in response to an uncompleted call to the service subscriber; and
issuing the call setup message into a common channel signaling (CCS) network to initiate the establishment of the call connection directly to the voice mail box of the service subscriber.

2. A method as claimed in claim 1 wherein the CCS network uses signaling system 7 (SS7) protocol, and the step of formulating a call set-up message further comprises steps of:
instantiating an integrated users digital network-user part (ISUP) initial address message (IAM);
inserting a directory number (DN) of the VMS into a called party number parameter in the IAM; and
inserting a redirecting number parameter, an original called number parameter, and a redirection information parameter into the IAM, in conformance with a SS7 standard.

3. A method as claimed in claim 2 wherein the step of inserting comprises a step of inserting the service subscriber's DN into the original called number and the redirecting number parameters, in conformance with the SS7 standard.

4. A method as claimed in claim 2 wherein the step of inserting further comprises a step of inserting a redirecting reason code into a redirection information parameter, the reason code being used by the VMS to select a voice mail prompt to play to the calling party.

5. A method as claimed in claim 2 wherein the step of inserting further comprises a step of inserting a redirecting reason code into the redirection information parameter, the reason code being a default value indicating that the reason for redirection is unknown or not available.

6. A method of providing direct access to a voice mail box of a service subscriber to a voice mail system (VMS), the method comprising steps of:
receiving at a call control application, a message sent in response to a request for direct access to the voice mail box by a requesting party;
formulating a call setup message for initiating establishment of a call connection between the requesting party and the VMS, the call setup message having a format reserved for a redirected call setup message issued by a service switching point (SSP) in response to an uncompleted call to the service subscriber; and
sending the call set-up message into the CCS network to initiate the establishment of the call connection.

7. A method as claimed in claim 6 wherein the CCS network uses signaling system 7 (SS7) protocols, and the step of formulating a call setup message further comprises steps of:
instantiating a default integrated users digital network-user part (ISUP) initial address message (IAM);
inserting a directory number (DN) of the VMS's into a called party number parameter of the IAM; and
inserting a redirecting number parameter and an original called number parameter in the IAM, in conformance with a SS7 standard.

8. A method as claimed in claim 7 wherein the step of inserting comprises a step of inserting a DN of the service subscriber into the original called number and redirecting number parameters, in conformance with the SS7 standard.

9. A method as claimed in claim 8 further comprising a step of inserting a redirecting reason code into a redirection information parameter, the redirecting reason code identifying the IAM as a request to leave a voice message with a direct to voice mail call.

10. A method as claimed in claim 8 further comprising a step of inserting a default value redirecting reason code into the redirection information parameter.

11. A method as claimed in claim 8 wherein the step of receiving the message comprises steps of:
receiving a connection request message; and
inspecting the connection request message to remove three identifiers; a requesting party identifier, a service subscriber identifier, and a VMS identifier.

12. A method as claimed in claim 11 wherein the step of receiving a connection request message comprises a step of receiving over an Internet protocol (IP) connection, from a server on the Internet adapted to receive click-to-voice mail notifications from at least one worldwide web page, a connection request message that conforms to a predefined format and includes directory numbers for the requesting party, service subscriber and VMS.

13. A method as claimed in claim 12 further comprising steps of:
initiating an establishment of a call connection between the requesting party's DN and a virtual instance of a call control node (CCN) prior to the step of sending; and
effecting an extension of the call connection from the virtual instance of the CCN to the VMS with the step of sending.

14. A method as claimed in claim 11 wherein the step of receiving comprises a step receiving a reconnect request message from call termination equipment, the reconnect connect message including a DN of the call termination equipment, a DN of the requesting party, a DN of the service subscriber and a DN of the VMS.

15. A method as claimed in claim 14 further comprising steps of:
effecting a forward release of a part of the established call connection between a virtual instance of the CCN and the call termination equipment; and
initiating an establishment of an extension the established call connection from the virtual instance of the CCN to the VMS with the step of sending.

16. A system for enabling a requesting party to initiate a telephone call directly to a voice mail box associated with a service subscriber to a voice mail system (VMS), comprising:
a call control node configured as a virtual service switching point in a switched telephone network, the call control node being adapted to receive a message requesting setup of a direct call to a voice mail box, and to respond to the message by formulating a call set-up message to initiate establishment of a call connection to the VMS, the call set-up message having a format reserved for redirected call set-up messages used by service switching points (SSPs) to redirect uncompleted calls to the service subscriber, so that the VMS provides access to the voice mail box.

17. A system as claimed in claim 16 wherein the call control node comprises an interface to a common channel signaling (CCS) network that operates under a signaling system 7 (SS7) protocol, and the call set-up message is an integrated services digital network-user part (ISUP) initial advisory message (IAM).

18. A system as claimed in claim 17 wherein the call control node further comprises:
means for formulating an IAM;
means for inserting a directory number (DN) of the VMS into a called party number parameter of the IAM, in conformance with a SS7 standard; and
means for inserting an original called number parameter, a redirecting number parameter and a redirection information parameter into the IAM, the redirecting number parameter containing a DN of the service subscriber, in conformance with the SS7 standard.

19. A system as claimed in claim 18 wherein the call control node further comprises means for inserting a redirecting reason code into the redirection information parameter.

20. A system as claimed in claim 19 wherein the call control node comprises a call control application (CCA) adapted to control the call control node (CCN), and the CCA is further adapted to receive the message requesting the establishment of the direct call to the voice mail box.

21. A system as claimed in claim 20 wherein the CCN is a virtual switching point in the call connection, and the connection request message is a reconnect request message from call termination equipment, and the reconnect request message contains a DN of the call termination equipment, a DN of the requesting party, a DN of the service subscriber, and a DN of the VMS.

22. A system as claimed in claim 21 further comprising a directory service database adapted to supply the call termination equipment with the DN of the VMS, and the DN of the service subscriber.

23. A system as claimed in claim 22 wherein the directory service database is further adapted to supply the call termination equipment with a redirecting reason code in response to a query.

24. A system as claimed in claim 21 wherein the CCA is further adapted to receive the reconnect request message, and to initiate a release by the CCN of a part of the established call connection between a virtual instance of the CCN and the telephony equipment, and to initiate an extension of the established call connection by the CCN between the virtual instance of the CCN and the VMS using the IAM.

25. A system as claimed in claim 20 further comprising an worldwide web server adapted to receive click-to-voice mail notifications from at least one web page and to relay a connection request message to the CCA, conforming to a predefined format.

26. A system as claimed in claim 25 wherein the connection request message is relayed through a proxy server.

27. A system as claimed in claim 25 wherein the connection request message contains the DNs of the requesting party, service subscriber and VMS.

28. A system as claimed in claim 21 further comprising a database adapted to supply the proxy server with the DN of the VMS, the DN of the service subscriber in response to a query.

29. A system as claimed in claim 28 wherein the database is further adapted to supply the proxy server with and a redirecting reason code in response to the query.

30. A system for providing a directory service with a direct to voice mail option for voice mail system (VMS) service subscribers, comprising:
a directory service that permits a requesting party to communicate an identifier used to locate a directory record associated with the VMS service subscriber, the directory service being adapted to provide the requesting party with an option to be connected directly to the VMS service subscriber's voice mail box after the record is located; and
means for formulating a common channel signaling initial address message (IAM) containing a redirecting number parameter to connect the requesting party directly to the voice mail box of the VMS service subscriber.

31. The system as claimed in claim 30 wherein the directory service is instantiated on call termination equipment adapted to receive dial-up connections from the public switched telephone network (PSTN) and to interact with the requesting party.

32. The system as claimed in claim 31 wherein the directory service is a directory service application is instantiated on a worldwide web server adapted to interact with the requesting party through the Internet.

33. The system as claimed in claim 30 wherein the means for formulating a common channel signaling initial address message (IAM) is a call control node (CCN) that is configured as a virtual switching point in the public switched telephone network (PSTN) and a physical node in a common channel signaling network of the PSTN.

34. The system as claimed in claim 33 wherein the CCN comprises a call control application (CCA) that is adapted to interface with an Internet Protocol (IP) network, and further adapted to provide control functions to the CCN.

35. A system for providing a click to voice mail option accessed from a server on an internet protocol (IP) network, comprising:
a user interface for permitting a requesting party to select the click to voice mail option, the click to voicemail option being associated with a particular voice mail box of a voice mail system (VMS) subscriber;
means for forwarding a message requesting setup of a connection directly to the voice mail box; and
means for receiving the message and formulating a common channel signaling system initial address message (IAM) containing a directory number of the VMS inserted in a called party number parameter of the IAM and a directory number of the VMS service subscriber inserted in the redirecting number parameter of the IAM.

36. A system as claimed in claim 35 wherein the means for receiving the message comprises a call control node (CCN) adapted to receive messages from the IP network, and to formulate and send the IAM into the common channel signaling network.

37. A system as claimed in claim 36 wherein the CCN is configured as a physical node in the common channel signaling network and as a virtual switching point in a switched telephone network associated with the common channel signaling network.

38. A system as claimed in claim 35 wherein the user interface is provided by one of a worldwide web page and an electronic mail message.

39. A system as claimed in claim 38 wherein the means for forwarding comprises the worldwide web server.

40. A system as claimed in claim 38 wherein the means for forwarding comprises a proxy server that receives the message requesting setup of a connection directly to the voice mail box and forwards the message to a call control node adapted to receive messages from the IP network.
